(19) United States
(12) Patent Application Publication
(10) Pub. No.: US 2026/0148721 A1
(43) Pub. Date: May 28, 2026

(54) ELECTRONIC GUITAR WITH DISPLAY FUNCTION

(71) Applicants: Guangzhou Huancheng Cultural Media Co., Ltd., Guangzhou (CN); Dongguan Midiplus Electronic Technology Co., Ltd., Dongguan (CN)

(72) Inventors: Shuo JIA, Guangzhou (CN); Haojun ZHENG, Guangzhou (CN); Li TIAN, Guangzhou (CN); Zhihong LI, Dongguan (CN); Shaomin LIU, Dongguan (CN); Chaoyi ZHANG, Dongguan (CN)

(21) Appl. No.: 19/454,530

(22) Filed: Jan. 21, 2026

(30) Foreign Application Priority Data
Jul. 18, 2025 (CN) 202521519335.4
Jul. 29, 2025 (CN) 202521590449.8
Nov. 17, 2025 (CN) 202522430716.1

(51) Int. Cl. G10H 1/34; G10H 1/00

(52) U.S. Cl. CPC G10H 1/342; G10H 1/0008; G10H 2220/101; G10H 2220/191

(57) ABSTRACT

An electronic guitar with a display function includes a body and a display assembly. The body includes a housing. The display assembly includes a display screen capable of flipping. The display screen is configured to flip inward in the inward-flipping state and flip outward in the outward-flipping state. The display assembly further includes a monitoring module, which is configured to monitor a flipping state of the display screen. The monitoring module includes a sensing magnet and a magnetic-induction module. The sensing magnet is arranged on the display screen, and the magnetic-induction module is arranged on the housing.

### CROSS-REFERENCE TO RELATED APPLICATIONS

This application claims the benefit of priority from Chinese Patent Application No. 202521519335.4, filed on Jul. 18, 2025, Chinese Patent Application No. 202522430716.1, filed on Nov. 17, 2025, and Chinese Patent Application No. 202521590449.8, filed on Jul. 29, 2025. The content of the aforementioned application, including any intervening amendments thereto, is incorporated herein by reference in its entirety.

### TECHNICAL FIELD

This application relates to electronic guitars, and more particularly to an electronic guitar with a display function.

### BACKGROUND

In the existing technologies, most electronic guitars have a housing made of plastic, which is similar in shape to a traditional guitar. An electronic component, such as a control circuit board, a sensor and a speaker, is arranged inside or on an outer surface of the housing. A cooperation of the control circuit board and the sensor is adopted, rather than a string of the traditional guitar to generate a sound control signal. The speaker is controlled to make sounds.

Furthermore, most electronic guitars rely on a connection with an external device (such as a smart phone, a tablet computer, etc.) to enable a display function of viewing sheet music and equipment status. As a consequence, these electronic guitars require to be connected to the external device for using every time, causing an inconvenience to check during performance, especially when playing while standing due to a fixed position of the external device.

### SUMMARY

An object of the present disclosure is to provide an electronic guitar with a display function for addressing the above problem. The electronic guitar with the display function requires no external device to enable a display function of viewing sheet music and equipment status, thereby facilitating using and checking, and making it more appealing to customers.

To achieve the above objectives, the following technical solutions of the present disclosure are adopted herein.

An electronic guitar with a display function, comprising:
a body; and
a display assembly;
wherein the body comprises a housing; and the display assembly comprises a display screen capable of flipping.

In some embodiments, the display screen has an inward-flipping state and an outward-flipping state; the display screen is configured to flip inward in the inward-flipping state and flip outward in the outward-flipping state; the display assembly further comprises a monitoring module; the monitoring module is configured to monitor a flipping state of the display screen; and
in response to a case that the display screen is in the inward-flipping state, the display screen is configured to display a first preset interface; and in response to a case that the display screen is in the outward-flipping state, the display screen is configured to display a second preset interface.

In some embodiments, the monitoring module comprises a sensing magnet and a magnetic-induction module; the sensing magnet is arranged on the display screen; and the magnetic-induction module is arranged on the housing.

In some embodiments, the display screen is provided with a plurality of movable magnets; the housing is provided with a plurality of fixed magnets respectively corresponding to the plurality of movable magnets; the number of the plurality of fixed magnets is the same as the number of the plurality of movable magnets; and
in response to a case that the display screen flips inward to approach to the housing, the plurality of movable magnets are configured to correspondingly attract the plurality of fixed magnets.

In some embodiments, the housing is provided with an accommodating groove configured for accommodating the display screen.

In some embodiments, a snap groove is formed on an edge of the accommodating groove.

In some embodiments, the electronic guitar further comprises a flat plucking device; the flat plucking device comprises a base arranged on the body, and a plurality of flat plucking modules; each of the plurality of flat plucking modules comprises a slider, a sensing magnet arranged on the slider, and a magnetic-induction module arranged on the base; the slider is slidably connected to the base along a lateral direction of the electronic guitar; and the magnetic-induction module is configured to measure displacement and speed of the sensing magnet.

In some embodiments, the slider is provided with a plucking tab.

In some embodiments, the plucking tab is configured as a rectangular block.

In some embodiments, a bottom of the plucking tab is connected to the slider; and two ends of a top of the plucking tab are each configured as a rounded corner.

In some embodiments, each of the plurality of flat plucking modules further comprises a return assembly configured for driving the slider to return to an initial position.

In some embodiments, the return assembly comprises a movable magnet arranged on at least one side of the slider, and a fixed magnet arranged on at least one side of the base; the number of fixed magnets is the same as that of the movable magnets; the fixed magnet is arranged corresponding to the movable magnet; and the fixed magnet is configured to correspondingly repel the movable magnet.

In some embodiments, the return assembly comprises at least one compression return spring.

In some embodiments, the number of the plurality of flat plucking modules is two.

Compared to the prior art, the present disclosure has the following beneficial effects.

The present disclosure provides the electronic guitar with the display function, including the body and the display assembly. The body includes the housing. The display assembly includes the display screen capable of flipping.

Compared to traditional electronic guitars, the electronic guitar provided herein is provided with the display assembly and requires no external device to enable the display function of viewing sheet music and equipment status, thereby facilitating using and checking, and making it more appealing to customers. Furthermore, compared with only being able to view the display screen from a single perspective, the display screen of the present disclosure can be flipped, thus enabling multi-perspective adjustment according to specific usage conditions and facilitating better viewing of the display screen.

### BRIEF DESCRIPTION OF THE DRAWINGS

FIG. 1 structurally shows a display screen according to an embodiment of the present disclosure (in an inward-flipping state);

FIG. 2 structurally shows the display screen according to an embodiment of the present disclosure (in an outward-flipping state);

FIG. 3 structurally shows an internal structure of the display screen according to an embodiment of the present disclosure;

FIG. 4 structurally shows an internal structure of an accommodating groove according to an embodiment of the present disclosure;

FIG. 5 structurally shows a flat plucking device according to an embodiment of the present disclosure;

FIG. 6 structurally shows the flat plucking device in FIG. 5 from another perspective;

FIG. 7 structurally shows a flat plucking device according to another embodiment of the present disclosure; and

FIG. 8 structurally shows a flat plucking device according to another embodiment of the present disclosure.

In the figures: 1—body; 2—housing; 21—accommodating groove; 22—snap groove; 3—display assembly; 31—display screen; 32—monitoring module; 321—first sensing magnet; 322—first magnetic-induction module; 4—first movable magnet; 5—first fixed magnet; 6—flat plucking device; 61—base ; 62—flat plucking module; 621—slider; 622—second sensing magnet; 623—second magnetic-induction module; 624—plucking tab; 625—return assembly; 6251—second movable magnet; 6252—second fixed magnet; and 6253—compression return spring.

### DETAILED DESCRIPTION OF EMBODIMENTS

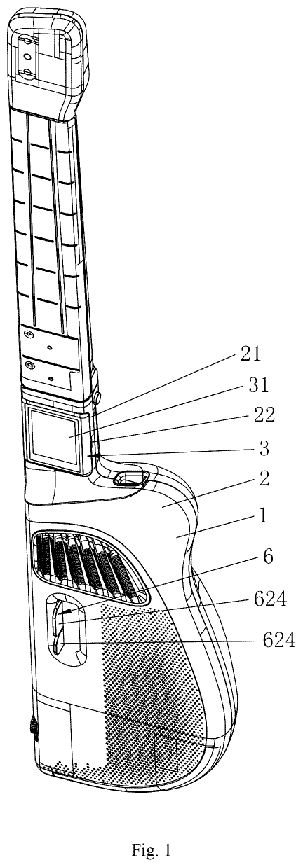

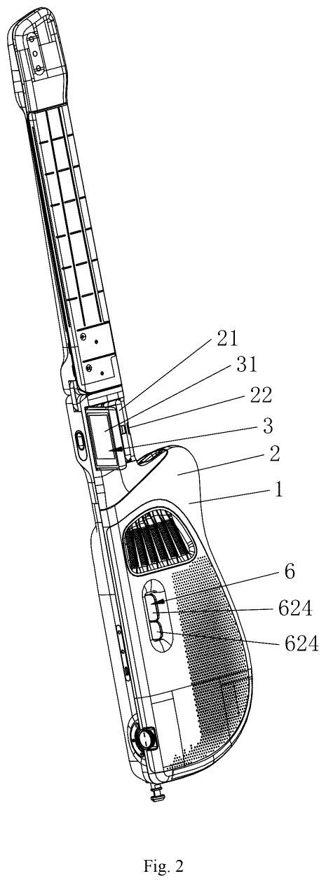

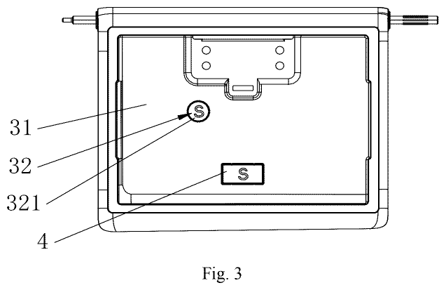

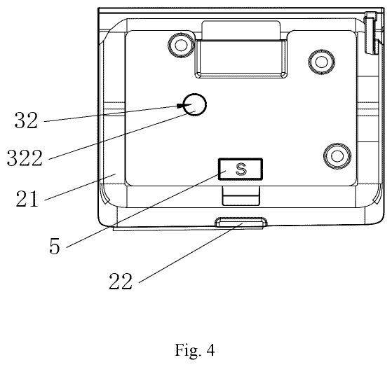

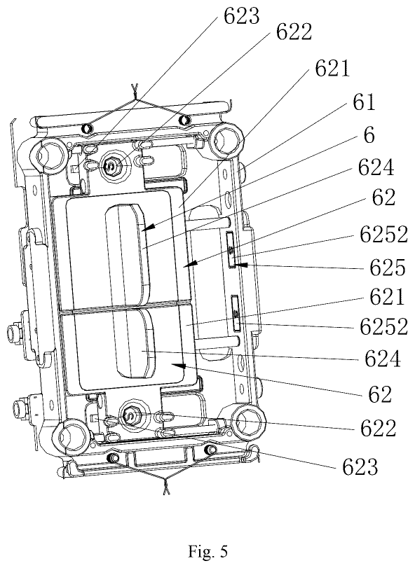

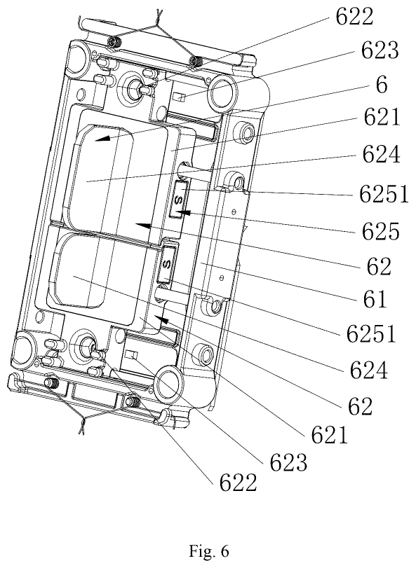

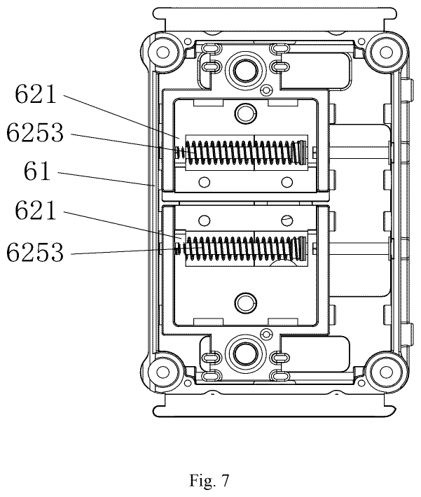

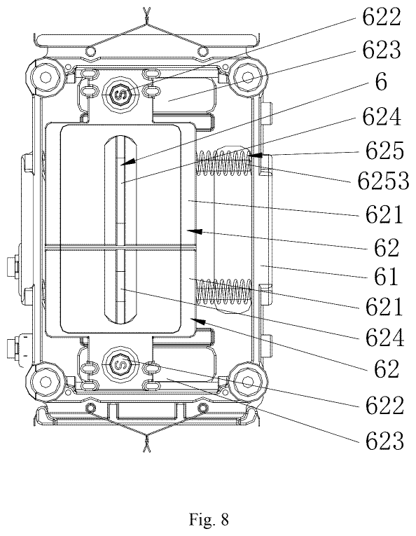

Referring to FIGS. 1-8, the present disclosure will be further illustrated below in combination with the accompanying figures.

The present disclosure provides an electronic guitar, including a body 1 and a display assembly 3. The body 1 includes a housing 2. The display assembly 3 includes a display screen 31 capable of flipping.

Compared to traditional electronic guitars, the electronic guitar provided herein is provided with the display assembly 3 and requires no external device to enable a display function of viewing sheet music and equipment status, thereby facilitating using and checking, and making it more appealing to customers. Furthermore, compared with only being able to view the display screen 31 from a single perspective, the display screen 31 of the present disclosure can be flipped, thus enabling multi-perspective adjustment according to specific usage conditions and facilitating better viewing of the display screen 31.

In some embodiments, the display screen 31 has an inward-flipping state and an outward-flipping state. The display screen 31 is configured to flip inward in the inward-flipping state and flip outward in the outward-flipping state. The display assembly 3 further includes a monitoring module 32. The monitoring module 32 is configured to monitor a flipping state of the display screen 31. When the display screen 31 is in the inward-flipping state, the display screen 31 is configured to display a first preset interface. When the display screen 31 is in the outward-flipping state, the display screen 31 is configured to display a second preset interface. When the display screen 31 approaches the housing 2 in the inward-flipping state, the display screen 31 is configured to display the first preset interface, such as a brand logo. When the display screen 31 is away from the housing 2 in the outward-flipping state, the display screen 31 is configured to display the second preset interface, such as a sheet music, a battery level, a volume, a mode and a parameter, so as to facilitate checking in real time and playing the electronic guitar.

The present disclosure enables monitoring the flipping state of the display screen 31 in real time through the monitoring module 32 and automatically switch back and forth between the first preset interface and the second preset interface without a manual operation, which greatly enhances the overall practicality.

In some embodiments, the monitoring module 32 includes a first sensing magnet 321 and a first magnetic-induction module 322, where the first sensing magnet 321 is arranged on the display screen 31, and the first magnetic-induction module 322 is arranged on the housing 2.

In some embodiments, the housing 2 is provided with a button, which is conducive to determining the flipping state of the display screen 31. In other words, the display screen 31 is configured to press the button to determine the flipping state of the display screen 31. The display screen 31 is configured to press the button in the inward-flipping state and stop pressing the button in the outward-flipping state.

Compared to the prior art, the present disclosure enables a contactless induction monitoring through the cooperation of the first sensing magnet 321 and the first magnetic-induction module 322, so as to better monitor the flipping state of the display screen 31 in real time and enable an automatic back-and-forth switching of the first preset interface and the second preset interface.

In some embodiments, the display screen 31 is provided with a plurality of first movable magnets 4. The housing 2 is provided with a plurality of first fixed magnets 5 respectively corresponding to the plurality of first movable magnets 4. The number of the plurality of first fixed magnets 5 is the same as the number of the plurality of first movable magnets 4. When the display screen 31 flips inward to approach the housing 2, the plurality of first movable magnets 4 are configured to correspondingly attract the plurality of first fixed magnets 5. Through the above arrangements, the display screen 31 can be more stably attached to the housing 2 when flipping inward to approach the housing 2.

In some embodiments, the housing 2 is provided with an accommodating groove 21 configured for accommodating the display screen 31. The accommodating groove 21 enables the display screen 31 to be accommodated into the housing 2, which not only makes the overall appearance more aesthetically pleasing but also better prevents the display screen 31 from protruding outside the housing 2 and getting bumped when not in use.

In some embodiments, a snap groove 22 is formed on an edge of the accommodating groove 21. By setting the snap groove 22, the display screen 31 is hidden in the accommodating groove 21 while making it more convenient to flip and open the display screen 31 outward.

In some embodiments, the electronic guitar further includes a flat plucking device 6. The flat plucking device 6 includes a base 61 arranged on the body 1, and a plurality of flat plucking modules 62. Each of the plurality of flat plucking modules 62 includes a slider 621, a second sensing magnet 622 arranged on the slider 621, and a second magnetic-induction module 623 arranged on the base 61. The slider 621 is slidably connected to the base 61 along a lateral direction of the electronic guitar. The second magnetic-induction module 623 is configured to measure displacement and speed of the second sensing magnet 622.

Compared to traditional string-plucking instruments that produce sound through the vibration of strings in the prior art, the flat plucking device 6 provided herein replaces a string-plucking function of the traditional string-plucking instruments by using the slider 621, the second sensing magnet 622 and the second magnetic-induction module 623 in combination. The flat plucking device 6 provided herein, by plucking the slider 621, causes the second sensing magnet 622 on the slider 621 to generate displacement accordingly. The displacement and speed of the slider 621 are measured and sensed by the second magnetic-induction module 623. By one-to-one matching different plucking conditions with measurement results of the second magnetic-induction module 623, plucking force and speed of the slider 621 can be inferred. Then, by combining pre-defined note data inside the electronic guitar with plucking force data inside, different sounds can be output, thereby simulating the string-plucking function of the traditional string-plucking instruments without damaging the fingers. The flat plucking device 6 provided herein not only can avoid an injury of a string to a finger, but also is more in line with a playing method of the traditional string-plucking instruments. Moreover, it can better simulate the string-plucking function of the traditional string-plucking instruments and be better applied to various electronic string-plucking instruments. Furthermore, compared to a rotary-type plucking measurement, that is, the slider 621 is rotatably connected to the base 61, the present disclosure adopts a flat plucking measurement, that is, the slider 621 is slidably connected to the base 61, which can better fit and simulate a string-plucking feel of the traditional string-plucking instruments, causing a better overall feeling.

In some embodiments, the slider 621 is provided with a plucking tab 624. The plucking tab 624 is configured as a rectangular block. The plucking tab 624 is plucked to drive the slider 621 to slide, which can further fit and simulate the string-plucking feel of the traditional string-plucking instruments, causing the better overall feeling.

In some embodiments, a bottom of the plucking tab 624 is connected to the slider 621. Two ends of a top of the plucking tab 624 are each configured as a rounded corner, so as to achieve an overall aesthetic and prevent hands from being scratched.

In some embodiments, each of the plurality of flat plucking modules 62 further includes a return assembly 625 configured for driving the slider 621 to return to an initial position. The return assembly 625 is configured to enable the slider 621 to automatically return to the initial position, which can greatly simulate the string-plucking feel of the traditional string-plucking instruments.

In some embodiments, the return assembly 625 includes a second movable magnet 6251 arranged on at least one side of the slider 621 and a second fixed magnet 6252 arranged on at least one side of the base 61. The number of second fixed magnets 6252 is the same as that of second movable magnets 6251. The second fixed magnet 6252 is arranged corresponding to the second movable magnet 6251. The second fixed magnet 6252 is configured to correspondingly repel to the second movable magnet 6251.

In some embodiments, when the slider 621 is plucked to a side, such as a left side, as the slider 621 slides, the second movable magnet 6251 arranged on the left side of the slider 621 gradually approaches the second fixed magnet 6252 arranged on the left side of the base 61. The second movable magnet 6251 arranged on the left side of the slider 621 repels to the second fixed magnet 6252 arranged on the left side of the base 61. When the slider 621 is released, the slider 621 automatically returns to a right side under the repulsive force of the second movable magnet 6251 arranged on the left side of the slider 621 and the second fixed magnet 6252 arranged on the left side of the base 61.

In some embodiments, when the slider 621 is plucked to a right side, as the slider 621 slides, the second movable magnet 6251 arranged on the right side of the slider 621 gradually approaches the second fixed magnet 6252 arranged on the right side of the base 61. The second movable magnet 6251 arranged on the right side of the slider 621 repels to the second fixed magnet 6252 arranged on the right side of the base 61. When the slider 621 is released, the slider 621 automatically returns to a left side under the repulsive force of the second movable magnet 6251 arranged on the right side of the slider 621 and the second fixed magnet 6252 arranged on the right side of the base 61.

In some embodiments, by arranging the second movable magnet 6251 on a side of the slider 621 and arranging the second fixed magnet 6252 on a side of the base 61, the slider 621 is configured to be plucked to a single direction and enable an automatic return.

In some embodiments, the return assembly 625 further includes two second movable magnets 6251 respectively arranged on two sides of the slider 621 and two second fixed magnets 6252 respectively arranged on two sides of the base 61, so as to allow the slider 621 to be plucked to two different directions, thereby enabling an automatic return. By plucking the slider 621 to different directions, various plucking performance effects can be achieved, making the overall plucking performance effect more diverse.

In some embodiments, the flat plucking device 6 includes two flat plucking modules 62. By respectively plucking the slider 621 of different flat plucking modules 62 to different directions, various plucking performance effects can be achieved, making the overall plucking performance effect more diverse.

In some embodiments, the return assembly 625 includes a compression return spring 6253. The compression return spring 6253 is clamped between a side of the slider 621 and the base 61. Or the compression return spring 6253 is arranged in the slider 621, where a first end of the compression return spring 6253 is configured to abut against the base 61, and a second end of the compression return spring 6253 is configured to abut against an inner side of the slider 621.The slider 621 is configured to be plucked to a single direction and enable an automatic return. After plucking, the slider 621 automatically returns to the initial position via the compression return spring 6253, which can improve the plucking feel and better simulate the string-plucking function of the traditional string-plucking instruments.

In some embodiments, the return assembly 625 includes two compression return springs 6253. The two compression return springs 6253 are clamped between two sides of the slider 621 and the base 61, respectively. Through the above arrangements, the slider 621 is configured to be plucked to two different directions and enable an automatic return.

A working principle of the electronic guitar provided herein is that the user directly flips the display screen 31 to a desired angle, so as to view the display screen 31. The manner in which the display screen 31 is rotatably arranged on the housing 2 through a pivot shaft with damping has been disclosed in the existing well-known general technology. For the sake of brevity, there is no elaboration.

Compared to traditional electronic guitars, the electronic guitar provided herein is provided with the display assembly 3 and requires no external device to enable the display function of viewing sheet music and equipment status, thereby facilitating using and checking, and making it more appealing to customers. Furthermore, compared with only being able to view the display screen 31 from a single perspective, the display screen 31 of the present disclosure can be flipped, thus enabling multi-perspective adjustment according to specific usage conditions and facilitating better viewing of the display screen 31.

Obviously, provided herein are merely preferable embodiments of the present disclosure, which are not intended to limit the present disclosure. It should be understood that various changes, modifications and equivalent replacements made by those skilled in the art without departing from the spirit of the present disclosure shall fall within the scope of the present disclosure defined by the appended claims.

What is claimed is:

1. An electronic guitar with a display function, comprising:
a body; and
a display assembly;
wherein the body comprises a housing; and the display assembly comprises a display screen capable of flipping.

2. The electronic guitar of claim 1, wherein the display screen has an inward-flipping state and an outward-flipping state; the display screen is configured to flip inward in the inward-flipping state and flip outward in the outward-flipping state; the display assembly further comprises a monitoring module; the monitoring module is configured to monitor a flipping state of the display screen; and
in response to a case that the display screen is in the inward-flipping state, the display screen is configured to display a first preset interface; and in response to a case that the display screen is in the outward-flipping state, the display screen is configured to display a second preset interface.

3. The electronic guitar of claim 2, wherein the monitoring module comprises a sensing magnet and a magnetic-induction module; the sensing magnet is arranged on the display screen; and the magnetic-induction module is arranged on the housing.

4. The electronic guitar of claim 1, wherein the display screen is provided with a plurality of movable magnets; the housing is provided with a plurality of fixed magnets respectively corresponding to the plurality of movable magnets; the number of the plurality of fixed magnets is the same as the number of the plurality of movable magnets; and
in response to a case that the display screen flips inward to approach to the housing, the plurality of movable magnets are configured to correspondingly attract the plurality of fixed magnets.

5. The electronic guitar of claim 1, wherein the housing is provided with an accommodating groove configured for accommodating the display screen.

6. The electronic guitar of claim 5, wherein a snap groove is formed on an edge of the accommodating groove.

7. The electronic guitar of claim 1, further comprising:
a flat plucking device;
wherein the flat plucking device comprises a base arranged on the body, and a plurality of flat plucking modules; each of the plurality of flat plucking modules comprises a slider, a sensing magnet arranged on the slider, and a magnetic-induction module arranged on the base; the slider is slidably connected to the base along a lateral direction of the electronic guitar; and the magnetic-induction module is configured to measure displacement and speed of the sensing magnet.

8. The electronic guitar of claim 7, wherein the slider is provided with a plucking tab.

9. The electronic guitar of claim 8, wherein the plucking tab is configured as a rectangular block.

10. The electronic guitar of claim 8, wherein a bottom of the plucking tab is connected to the slider; and two ends of a top of the plucking tab are each configured as a rounded corner.

11. The electronic guitar of claim 7, wherein each of the plurality of flat plucking modules further comprises a return assembly configured for driving the slider to return to an initial position.

12. The electronic guitar of claim 11, wherein the return assembly comprises a movable magnet arranged on at least one side of the slider, and a fixed magnet arranged on at least one side of the base; the number of the fixed magnets is the same as that of the movable magnets; the fixed magnet is arranged corresponding to the movable magnet;
and the fixed magnet is configured to correspondingly repel the movable magnet.

13. The electronic guitar of claim 11, wherein the return assembly comprises at least one compression return spring.

14. The electronic guitar of claim 7, wherein the number of the plurality of flat plucking modules is two.
